(19) United States
(12) Patent Application Publication
(10) Pub. No.: US 2009/0037834 A1
(43) Pub. Date: Feb. 5, 2009

(54) Site plan tool

(76) Inventor: William Parrish, Covina, CA (US)

Correspondence Address: Neville Law Group;Silicon Valley Office, PO Box 61063, Palo Alto, CA, 94306, US

(21) Appl. No.: 11/660,727

(22) PCT Filed: Mar. 21, 2006
(86) PCT No.: PCT/US06/10151

§ 371 Date: Feb. 16, 2007

Related U.S. Application Data
(60) Provisional application No. 60/694,866, filed on Jun. 29, 2005.

(51) Int. Cl. G06F 3/048

(52) U.S. Cl. 715/771

(57) ABSTRACT

The invention provides a simple to use site planning tool suitable useful in the field and capable of supporting site feasibility decision-making. Several advantages include cost savings owing to a) the expense of the tool itself (as compared with current CAD drawn site plans) and b) the compressed time-line to a decision-point regarding any site under consideration. More specifically, the invention provides a lightweight and intuitive design tool which requires no training to use, and permits a user to draw, to scale, property boundary lines within a browser interface and with or without an Internet connection. The invention further provides that a user may perform other rapid and scaled visualization concerning possible site plans, and to save site plans into a graphic file suitable for transmission and/or printing.

### RELATED APPLICATIONS

This application claims priority from U.S. provisional application 60/694,866 by the same inventor and title, filed Jun. 29, 2005, and the contents of which are incorporated as if fully set forth herein.

### GOVERNMENT FUNDING

Not applicable.

### BACKGROUND

Decisions about land parcels as potential building sites are important. Real estates brokers, design professionals, developers, architects and engineers all participate in assessment of land parcel suitability as building sites. Conventionally, the preparation of a so-called “conceptual site plan” has required use of commercially available CAD software such as AutoCAD or Microstation. However, most commercially available CAD programs require both investment in expensive software licenses and an experienced user. Typical CAD training programs require intensive study over an extended period, and operators, to be employable based on CAD skills, must acquire on-the-job experience in addition to training. Practically speaking, in many situations a CAD manager is also required.

When a site is under consideration for purchase, even an experienced real estate person cannot “eyeball” a layout on multi acre lots. Site planning involves an understanding of the retail use for which the site may be intended, as well as the related concepts such as building foot prints, parking layout, etc. To determine whether a lot might be further considered, the current process involves requesting a CAD draftsperson, typically in the employ of a civil engineer, to take a map of the site, and plot one or more possible planning configurations on the site. Such a rendering involves a significant amount of keystrokes for each orientation variation.

The drafting time for several alternate planning orientations on a given site can easily occupy 6 or more hours of draftsperson time, and the process from site visit to review of designs and decision on lot suitability or “sign-off” routinely consumes four or more entire days. What is needed is a tool for lot evaluation enabling a user with less technical knowledge and even less sophistication with respect to retail aspects of lot usage to make decisions about possible sites.

Often, a given geographic location presents a real estate person (e.g., corporate manager or developer) with a dozen or more potential sites to evaluate for suitability. It is common practice for the three or more decision makers to perform a series of site inspections together. Yet without a tool to support retention of some sites as potential choices and elimination of others, the physical site inspection may represent gross inefficiencies, consuming many hours of executive and management time.

While it is inefficient and costly to allocate several or more hours of drafting for each potential site, the inefficient use of high level employees represents an even greater waste. The delay from physical site inspection to a review of the site plan drawings handicaps the team of decision makers. The team of people (representing the multiple sign-offs required to enable a decision) cannot remain assembled for the four days, each likely having moved on to other business concerns. The energy expended to re-assemble and review drawings some days or even longer after the physical inspection is considerable; and the intervening time and attendant memory degradation saps the necessary clarity and focus to support crisp decision-making. What is needed is a means to aid in selection and/or elimination of a site from a list of possible sites that does not require hours of drafting nor days to complete a decision-making cycle.

In many cases, opportunities for choice real estate arise quickly in a competitive environment and action must be quick and decisive or the opportunity may be lost to a competitor. In such cases determination of site feasibility must be made virtually on the spot. It is desired that such decisions be aided and supported by a site feasibility assessment tool that takes into account real data—lot configuration, plat map data, building/prototype footprint, and property lines—all in proper scale and relation. What is desirable is a means for creating a conceptual site plan without the need for the services of persons trained in commercial CAD tools or persons with other specialized training or skills. Further needed is a means to create a conceptual site plan in a short time period so that real estate decisions can be made rapidly and efficiently. What is also desired is a means to create a conceptual site plan with a mobile device capable of functioning with or without internet access.

### BRIEF SUMMARY OF THE INVENTION

The invention taught herein provides a method for creating a conceptual site plan in a short time, without the need for costly CAD software and without special training. The invention provides a means for providing site feasibility assessments that takes into account real data—lot configuration, plat map data, size, acreage, building/prototype footprint, and property lines—all in proper scale and relation. Further provided is a means to create a conceptual site plan in a short time period so that real estate decisions can be made rapidly and efficiently. The invention also provides a means to create a conceptual site plan by means of a mobile device capable of functioning either with or without internet access (e.g., a “stand alone” program), so that on-site decisions can be made concerning lot suitability, thereby radically shortening the decision-making cycle.

The invention provides a design tool executable by means of computer readable instructions (i.e., software) which: (a) permits a user to draw (to scale) property boundary lines within a browser interface and with or without an Internet connection, by: (i) providing the user with both distance and bearing angle information in real time (i.e., as the user draws a line), (ii) providing Bezier line drawing capabilities along any point of a line, (iii) closing the boundary to the first point of the shape, (iv) providing the user with an area calculation of the shape (e.g., 43,560 SF/1 acre), and (v) allowing the user to import an aerial photographic image such that a drawing using such capabilities may be created over said image; and (b) allows users to (i) place custom configured prototype structures within customizable setback boundary lines, (ii) manipulate custom configured prototype structures within the boundary lines on a 360 degree platform, (iii) establish alternative parking configurations dependent on the structure location within the boundary lines, determine the number of parking spaces and ascertain the parking to building size ratios, and (iv) save the site plan into a graphic file format and to produce same in print format. An illustrative flow chart of the steps stated herein above is attached hereto as FIG. 1a and discussed herein below in more detail.

The invention provides computer implementable instructions via source code. Source code as used herein is the human readable set of instructions or textual computer program code relating to the invention, referred to as the “Site Planning Tool”, and suitable for making modifications to it, including all modules it contains, plus any associated interface definition files or scripts used to control compilation and installation of an executable (object) code. The source code for the Site Planning Tool is based, in part, on the Macromedia, Inc. (“Macromedia”) Director® MX 2004 and Flash® MX 2004 programming languages. For the purposes of this definition, “source code” includes the annotations and comments accompanying the set of instructions or text prepared in connection with the Site Planning Tool. The Site Planning Tool contains Macromedia® Director® and Flash® software by Macromedia, Inc.

### BRIEF DESCRIPTION OF THE DRAWINGS

FIG. 1a is a flowchart depicting a preferred embodiment.

FIG. 1b depicts a system according to the invention.

FIG. 2 depicts a first user screen according the preferred embodiment.

FIG. 3 depicts a second user screen according to the preferred embodiment.

FIG. 4 depicts a third user screen according to the preferred embodiment.

FIG. 5, a and b inclusive, depicts a fourth user screen according to the preferred embodiment.

FIG. 6 depicts a fifth user screen according to the preferred embodiment.

FIG. 7, a and b inclusive, depicts a sixth user screen according to the preferred embodiment.

### DETAILED DESCRIPTION OF THE PREFERRED EMBODIMENT

Many of the practical aspects of the invention do not require drawings to be understood; the figures presented are illustrative only, and not intended to limit the invention.

The invention provides a design tool—the current embodiment of the tool comprises computer implement-able software—which: (a) permits a user to draw, to scale, property boundary lines within a browser interface and with or without a network (e.g. the Internet, the World Wide Web, or, in some cases, private wide area networks or the like) connection, by: (i) providing the user with both distance and bearing angle information in real time (i.e., as the user draws a line), (ii) closing the boundary to the first point of the shape, (iii) providing Bezier line drawing capabilities along any point of a line, (iv) providing the user with an area calculation of the shape (e.g., 43,560 SF/i acre), and (v) allowing the user to import an aerial photographic image such that a drawing using such capabilities may be created over said image; and after boundary is drawn, then the user adds the setback, which is completely editable;

(b) allows users to (i) place custom configured prototype structures within boundary lines, (ii) create and manipulate custom configured prototype structures within the boundary lines on a 360 degree platform, (iii) establish alternative parking configurations dependent on the structure location within the boundary lines, determine the number of parking spaces and ascertain the parking to building size ratios, and (iv) save the site plan into a graphic file format and to produce same in print format.

The invention provides a means for persons such as, for example, real estate developers or corporate managers, to quickly and simply find out if a specific prototype building and related structures (parking, etc) can be effectively placed on a lot under consideration. The preferred embodiment provides tools which allow the user to: import aerial photography, draw site perimeter lines, create setbacks, insert one of various pre-drawn prototypes or create a custom building perimeter.

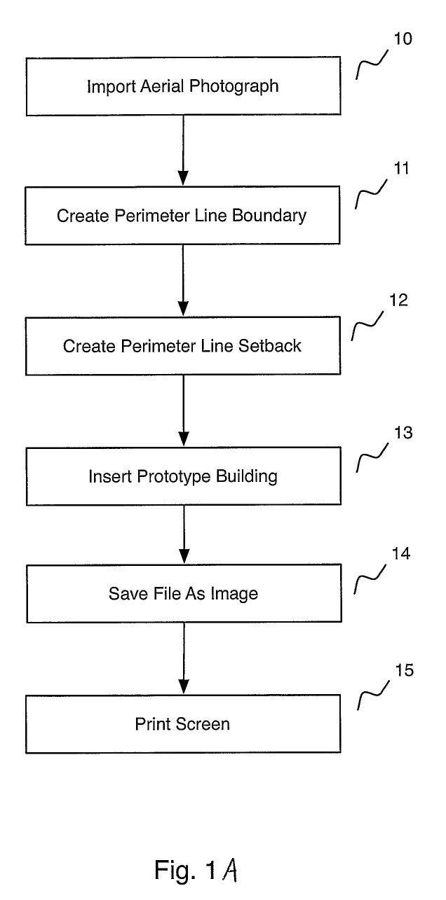

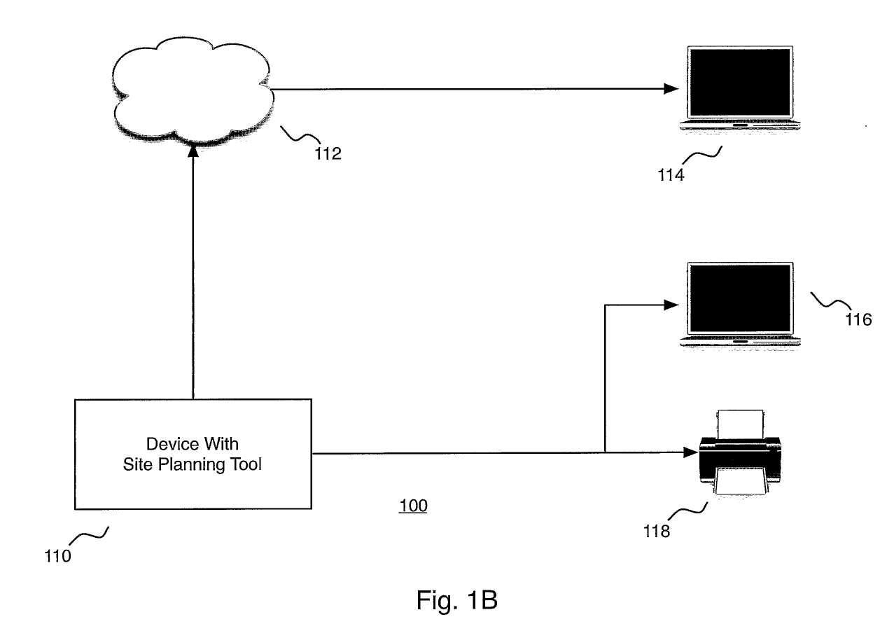

FIG. 1a depicts the preferred embodiment of the inventive method; it outlines steps—and choices—the user can take or make in using the inventive tool. While the current embodiment uses “point and click” user interface, any user interface (oral, haptic, etcetera) may be exploited. As depicted in FIG. 1a the steps (and associated functions) provided by the invention in its current embodiment include:
Import Aerial Photograph. 10: The User chooses an image from a computer to import into canvas. Scale the image, using a drag-able/rotatable scale to find the correct size.
Create Perimeter Line Boundary 11: The User begins by choosing which scale to draw (1-100, 1-200, 1-400); commence clicking on canvas (portion of area on display device wherein the image is creatable) to create the boundary. Each line segment has an angle and length to help the user recreate a precise site boundary. After the boundary is closed, the points can be manipulated to adjust the length and angle. The user can add or delete points on the boundary along with turning straight segments into curves. After the boundary is closed it can be moved anywhere on the canvas.

Create Perimeter Line Setback 12: The user has two options to create a setback. The first option gives a constant setback length (e.g., 60 feet) for all of the line segments. The second option permits different length setbacks for each segment. When creating the setback the square acreage is calculated and displayed.

Insert Prototype Building 13: User selects a pre-drawn prototype building by size, building orientation and parking configuration. After choosing the prototype, the user can drag and rotate the building anywhere on the canvas. At anytime the user can replace the selected prototype with another from the list.
The user can also decide to create a custom building. The custom building is drawn in manner similar to the drawing of the site boundary. After drawing the custom building, the square footage is calculated and the user can save the building to a memory storage device or computer for later use. The custom building can be dragged/rotated the same as the prototypes. The user can add additional “planning aides” to the canvas which may include: truck turn radius, ingress/egress arrows, additional parking fields and a notepad.
Save File as Image 14: This function turns the canvas into an image (e.g., jpeg, gif, etc,) which can then be shared with people via email or other network or wireless communication mediums.
Print Screen 15: This function prints the canvas.

The preferred embodiment provides source code operable to implement the invention. Source code as used herein is the human readable set of instructions or textual computer program code relating to the invention, referred to as the “Site Planning Tool”, and suitable for making modifications to it, including all modules it contains, plus any associated interface definition files or scripts used to control compilation and installation of an executable (object) code. According to the present preferred embodiment, the source code for the Site Planning Tool is based, in part, on the Macromedia, Inc. (“Macromedia”) Director® MX 2004 and Flash® MX 2004 programming languages. No limitation to a particular code is intended, and other language implementations are obvious to those of skill in the related art and are to be considered as within the purview of the invention claimed herein.

FIG. 1b depicts s system according to the invention. A system according to the preferred embodiment is depicted in FIG. 1b, which illustrates the operation of the Site Planning Tool in either a standalone mode or in a device in connection with other networked elements.

The number/elements of a system according to the present invention are as follows: a system including a device with the Site Planning Tool 100; a first device with the site planning tool 110; a network connection 112 (e.g. internet, wireless, wired etc); a second device 114—a remote receiving device capable of displaying the canvas created by the site planning tool—in the present embodiment, this remote device also contains a working version of the Site Plan Tool, and therefore the received image is as completely editable as if it had been created on the remote receiving device.

The network connection 112 connecting the first and second devices 110, 114 may be permit serial or simultaneous collaborative use of the Site Planning Tool and such uses may be enabled in a variety of ways. Currently, technologies such as “Whiteboard” (see, for example, www.imaginationcubed.com/Imagine) which works in Macromedia applications, provide ways to interconnect a first device 110 with the Site Planning Tool through a network connection 112 with a second device 114.

The system may include a third device 116 may be thought of as a “near receiving device”—which may display the image of the Site Plan Tool. A means of outputting the image a User has created with The Site Plan Tool in another embodiment, the third device 116 may also be capable of displaying the canvas form the first device 110. A means for outputting in tangible form 118, may of course be a printer or other device capable of reproducing the canvas by a variety of electronic or ink-based, or other means.

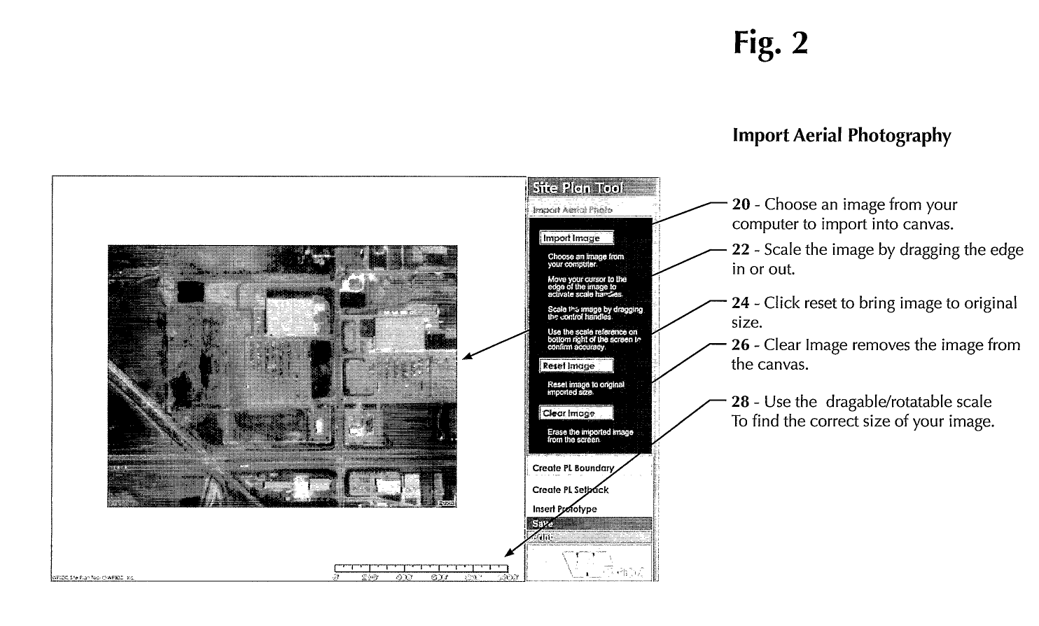

The inventive method FIG. 1a and system FIG. 1b are further illustrated in FIGS. 2-7 inclusive. FIGS. 2-7, inclusive, figures depict, by means of exemplar displays, how the preferred embodiment of invention provides user interface screens displayable on any device (including, but not limited to, lap top computer, notebook computer, or any device or appliance—PDA, smartphone, etc.—capable of supporting the computer implemented instructions associated with the invention as taught herein).

Referring to FIG. 2, the step, “Import Aerial Photography” (10 in FIG. 1) includes a number of sub-steps. The user may choose an image to import 20 (typically from a computer source whether or not databased—an internet map, tax map, plat map, etc.). If the image is not pre-scaled, the user may scale the image 22 by dragging the image edge in or out. The user may click on an interface user menu icon “reset image” to reset the image to its original size 24 or, similarly, click “clear image” to remove/clear image from the canvas 26. (We use the word “canvas” herein to denote the space (typically white) in which all drawings and modifications take place—that space which displays the results of the user choices. In the preferred embodiment, the canvas is alongside the menu screens presented to the user). The user may also use the draggable and rotatable scale 28 to find the desired image size.

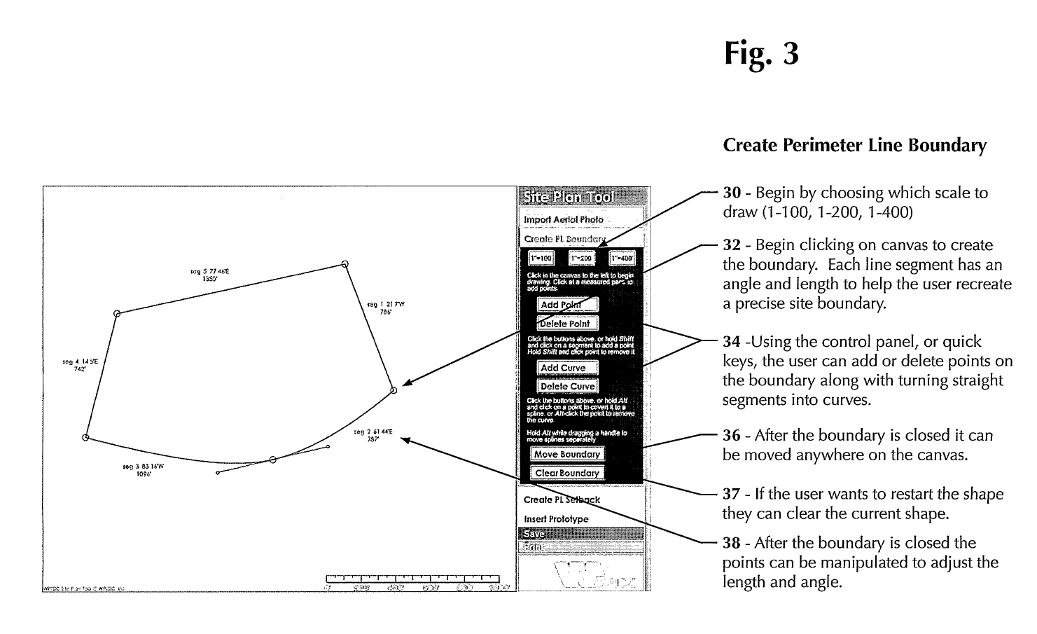

Referring to FIG. 3, the step “Create Perimeter Line Boundary” includes a number of sub-steps, executed by clicking buttons displayed to the user on the screen. The user may choose a drawing scale 30. The user then clicks on the canvas to create the boundary 32. Each line segment has an angle and length to allow the user to recreate a precise site boundary. Keys on the control panel (“quick keys”) permit the user to make modifications 34: add or delete points on the boundary, or modify straight or curved segments. Once the boundary is closed, the closed boundary may be moved, “move boundary” 36 on the canvas. Also, the user may manipulate the points—the ends of any line segment—to adjust the length and angle of boundary lines 38. Alternatively, the user may type in a line length or an angle and so modify. The user may also add and delete points and curves. The user may “clear boundary” 37, thereby deleting lines within the canvas.

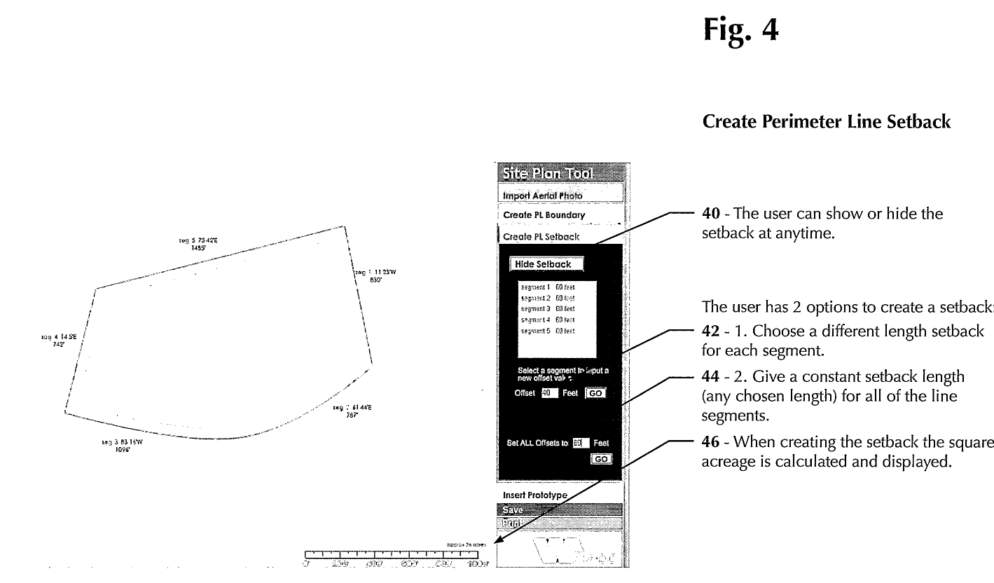

Referring to FIG. 4, for the step of creating a perimeter line set-back 12, the user again may see functions (sub-steps) presented as selectable or clickable regions on the interface, including showing (or not showing) the setback 40; choosing a different length setback for each perimeter line segment 42; giving a constant setback for all of the line segments 44. In the preferred embodiment, square acreage is calculated and displayed 46 on the canvas.

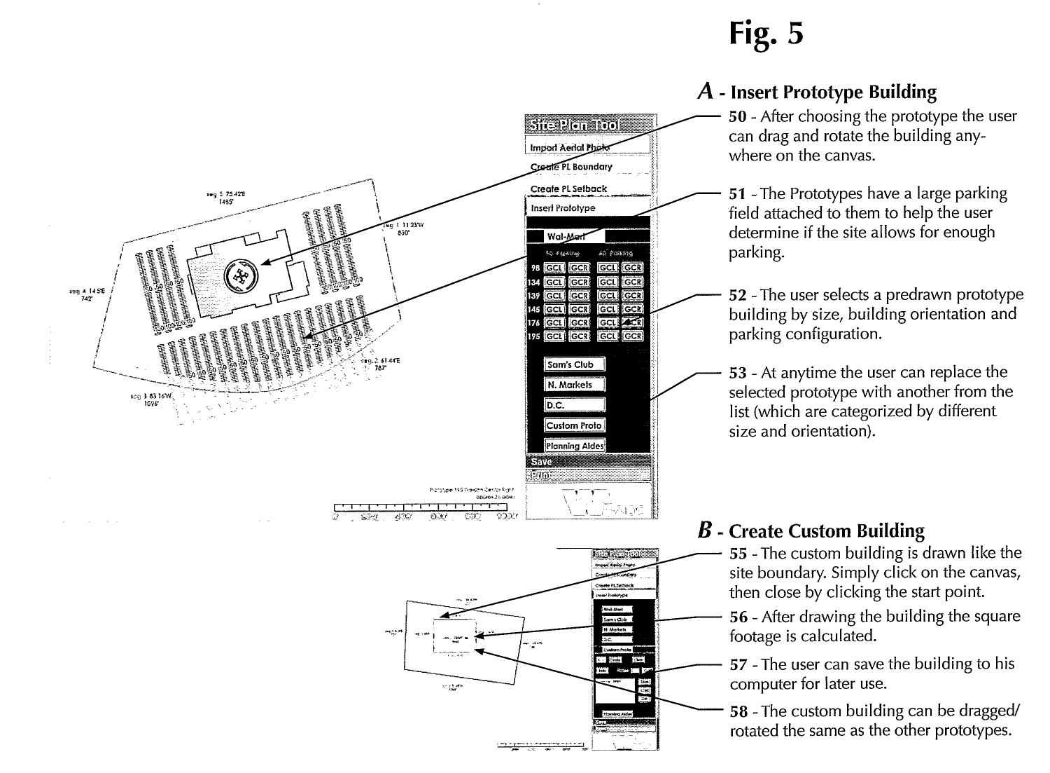

FIG. 5, A and B inclusive, provides exemplar screen shots of the step wherein the user may insert a prototype 13 building from a pre-drawn selection 52; in the preferred embodiment, building size, orientation and parking configuration are selection criteria. The prototypes in the preferred embodiment include parking fields to assist in assessment of adequate parking 51. Once inserted, the prototype may be positioned anywhere on the canvas 50 (dragged and rotated). The user may replace the prototype with another selection, or a custom prototype, and also may save an image 53.

The current embodiment includes a “create custom building” step option. The user may click on the canvas and commence to draw a boundary line 55. The boundary of a custom building is closed when the user clicks on the starting position. As with the prototype insertion, the custom building may be rotated or dragged 58; the square footage is calculated and displayed 56; and any drawn building can be saved for later retrieval 57.

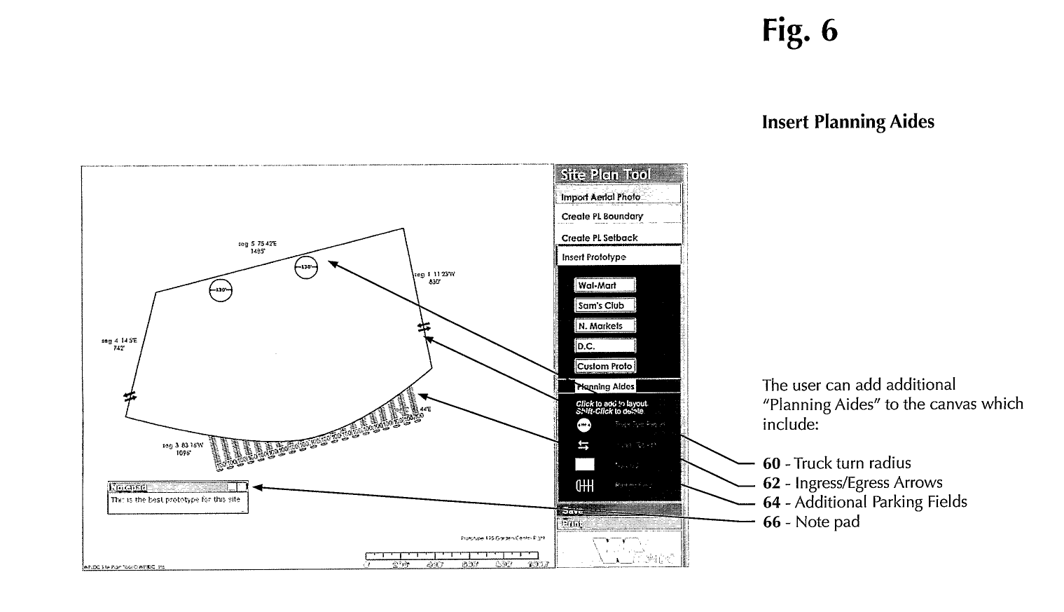

Referring to FIG. 6, the user can add “Additional Planning Aides” to the canvas which in the preferred embodiment include truck turn radius 60, ingress/egress arrows 63, additional parking fields 64, and note pad 66.

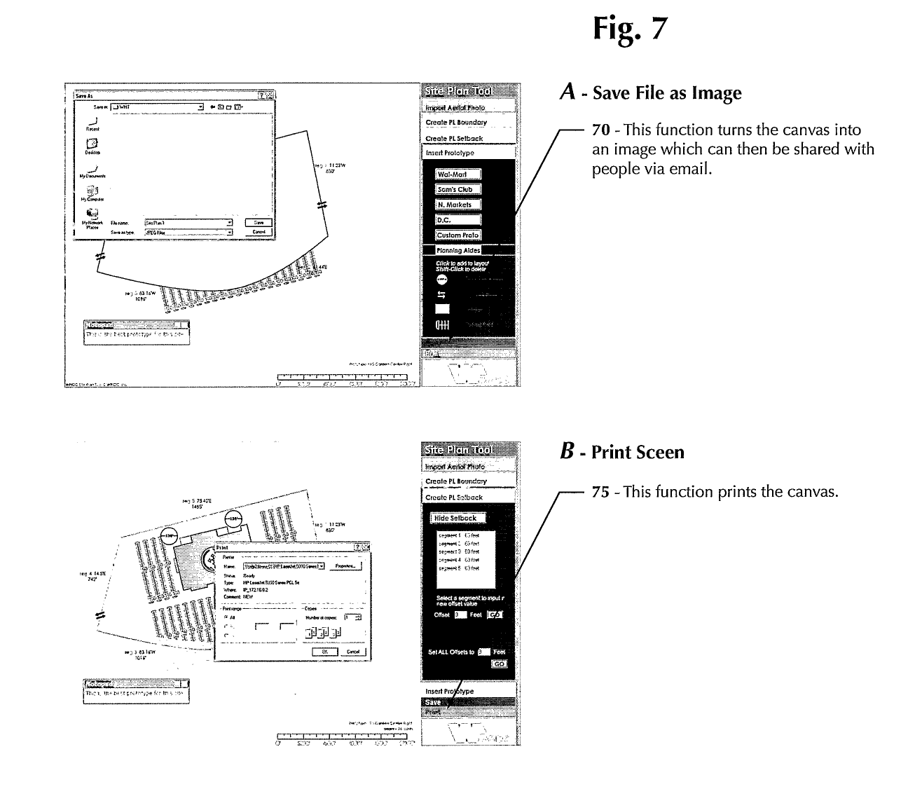

The preferred embodiment includes, as depicted in FIG. 7, A and B, inclusive, the steps of “saving” 14 the image on the canvas as a file 70 and “printing” 15 the image as appears on the canvas 75. It must be understood that any function that a “file” can undergo—i.e. transmission over any network, including the internet, etc.—may be applied to the image file 70. “Printing” in this case should be understood to include any post file creation manipulation, whether in the device of origin (the device upon which the canvas was created) or in some other device.

The invention is customizable—any code base for building planes or planar configurations can be created by taking a utility footprint (typically in a CAD format) distilling the utility footprint to a line drawing, add parking if desired, and then to create a graphic representation. The invention's code base thus permits a library of prototype footprints and planning aids to be stored and used in according to the present invention.

Although the examples discussed herein relate to real estate, and principally commercial real estate, the invention has application to any circumstance wherein a map image modification is desired. This includes residential real estate application. Also included are applications to maps of interior spaces, or any combination of interior and exterior spaces, as the term “map” is intended herein to have a broad meaning. It is considered that any application for which CAD may be useful, the invention taught herein may also be applied.

Other examples will be apparent to persons skilled in the art. The scope of this invention should therefore not be determined solely by reference to the above description and tables therein, but instead should be determined inclusive of reference to the appended claims and figures, along with the full scope of equivalents to which such claims are entitled.

1. A method for creating a conceptual site map, said site map consisting of a possible building footprint (footprint) displayed on an accurate current geographical map (map), wherein said method includes processing computer implementable instructions and a an interactive display enabled user device operable to display user selections of either the footprint or the map graphically, and in a precise and scaled depiction, and wherein a site of interest (map location) for said footprint has been selected by user, and a map of said site of interest is displayed on display means, said method comprising the steps of:
a) selecting boundary conditions as depicted on a scaled, graphical representation on display means;
b) selecting perimeter line setback;
c) selecting utility footprint of one or more preselected structures;
d) outputting results of steps a through c.

2. A site planning system comprising:
a) means for displaying a map image of a site of interest;
b) means for manipulating display of map image to create a “site map” image: wherein said “site map” image includes in the display a scaled superimposition of a building footprint, enabling a rapid determination of the fit of the footprint to a site of interest; and
c) means to output resulting site map image.

3. A site planning system as in claim 2 wherein said means for displaying a map image of a site of interest is a mobile display enabled device operable to receive user input.

4. A site planning system as in claim 2 wherein said means for displaying a map image of a site of interest is a display enabled device operable to receive user input.

5. A site planning system as in claim 2 wherein the map image is of an aerial map.

6. A site planning system as in claim 2 where the map image is of a tax map.

7. A site planning system as in claim 2 wherein said means for creating a site map image employs a “point and click” mechanism whereby the user indicates selection of building footprint elements by a “point and click” selection and similarly via “point and click” achieves changes to map image resulting in display of customized “site map” image.

8. A site planning system as in claim 7 wherein the creation of a site map image displayed so as perceived by user as scalably superimposed on said map image include the insertion of property boundary lines.

9. A site planning system as in claim 7 wherein the creation of a site map image displayed so as perceived by user as scalably superimposed on said map image includes the insertion of setback lines.

10. A site planning system as in claims 7 wherein the creation of a site map image displayed so as perceived by user as scalably superimposed on said map image include the insertion of templated utility footprints.

11. A site planning system as in claim 10 where said templated utility footprints are selected from a prepared menu of templated utility footprints stored in the site planning system.

12. A site planning system as in claim 11 where the utility footprints are custom footprints.

13. A site planning system as in claim 2 wherein the site map image is output to one or more associated imaging devices.

14. A site planning system as in claim 2 wherein the site map image is output wirelessly to a remote device.

15. A site planning system as in claim 2 wherein the site map image is stored.

16. A site planning device system as in claim 7 wherein the point and click mechanism employs a user interface including a keyboard and mouse.

17. A site planning system as in claim 7 wherein the point and click mechanism employs a user interface comprising an interactive “touch” screen.

18. A site planning system as in claim 4 where the site map image may be created by oral commands to the display enabled device.

19. A device enabling modification of map image, said device comprising:
display means,
means for modifying display; and
means for image output.

20. A device as in claim 18 wherein said device is wireless and network connectable.

21. Computer readable instructions operable to cause the performance of steps, in response to user interaction and in association with a display enabled device, where said display enabled device may be wirelessly networked to the Internet, said steps comprising:
a) permitting a user to draw (to scale) property boundary lines within a browser interface by
(i) providing the user with both distance and bearing angle information in real time (i.e., as the user draws a line);
(ii) closing the boundary to the first point of the shape;
(iii) providing Bezier line drawing capabilities along any point of a line;
(iv) providing the user with an area calculation of the shape; and
(v) allowing the user to import an aerial photographic image such that using such capabilities as listed herein, a drawing may be created and perceived as displayed as if superimposed over said aerial photographic image; and
(b) allowing a user to
(i) place custom configured prototype structures within property boundary lines,
(ii) manipulate customizable configured prototype structures within the property boundary lines on a 360 degree platform,
(iii) establish alternative parking configurations dependent on the structure location within the property boundary lines, determine the number of parking spaces and ascertain the parking-to-building-size ratios, and
(iv) save the site plan into a graphic file format and to produce the site plan in print format.
